(19) United States
(12) Patent Application Publication
(10) Pub. No.: US 2025/0321157 A1
(43) Pub. Date: Oct. 16, 2025

(54) Multi-Rotor Drag Coefficient Calibration Method, Device, and Computer-Readable Storage Medium

(71) Applicant: EHANG INTELLIGENT EQUIPMENT (GUANGZHOU) CO. LTD., Guangzhou (CN)

(72) Inventors: Huazhi Hu, Guangzhou, Guangdong (CN); Shike Xu, Guangzhou (CN)

(21) Appl. No.: 19/250,097

(22) Filed: Jun. 26, 2025

Related U.S. Application Data
(63) Continuation of application No. PCT/CN2023/139187, filed on Dec. 15, 2023.

(30) Foreign Application Priority Data
Dec. 28, 2022 (CN) 202211692800.5

(51) Int. Cl. G01M 9/06; G06F 17/11; G06F 17/17

(52) U.S. Cl. CPC G01M 9/06; G06F 17/11; G06F 17/17

(57) ABSTRACT

A method, device, and computer-readable storage medium for calibrating the drag coefficient of a multi-rotor aerial vehicle is disclosed. The method includes: conducting flight tests at multiple set airspeeds along a straight and level flight path in both windless and windy environments, and recording, by a flight control system, flight control logs based on a measurement sequence comprising airspeed, tilt angle, and acceleration during the flight tests; selecting corresponding measurement combinations for the acceleration, cruise, and deceleration phases in each flight control log; taking the least squares solution derived from a preset number of measurement combinations as the drag coefficient calibration result; and applying the drag coefficient calibration result to a preset real-time airspeed estimation algorithm to obtain the airspeed estimation result thereby verifying the accuracy of the drag coefficient calibration result and the estimation algorithm.

### CROSS REFERENCE TO RELATED APPLICATIONS

The present application is a Continuation Application of PCT Application No. PCT/CN2023/139187 filed on Dec. 15, 2023, which claims the benefit of Chinese Patent Application No. 202211692800.5 filed on Dec. 28, 2022. All the above are hereby incorporated by reference in their entirety.

### TECHNICAL FIELD

The present disclosure relates to the technical field of unmanned aerial vehicles, and in particular, to a multi-rotor drag coefficient calibration method, device, and computer-readable storage medium.

### BACKGROUND ART

Currently, the functional model between the drag coefficient and the tilt angle is a prerequisite for calculating the airspeed of a multi-rotor aerial vehicle (abbreviated as “multi-rotor” hereinafter) based on dynamics principles. Typically, a theoretical model of the drag coefficient for a multi-rotor can be established through aerodynamic analysis and computational fluid dynamics simulations.

However, due to the complex aerodynamic characteristics of multi-rotor aerial vehicles, it is difficult to derive an analytical expression for the functional relationship between the drag coefficient and the tilt angle from theoretical principles.

Existing computer simulations can provide an approximate solution, but these methods are constrained by model accuracy and computational power, resulting in high costs and unreliable precision.

Based on this, how to effectively calibrate the drag coefficient function of a multi-rotor aerial vehicle has become an urgent technical problem to be solved.

### SUMMARY

In view of this, the present disclosure proposes a multi-rotor drag coefficient calibration method, device, and computer-readable storage medium to address the technical problem that multi-rotor aerial vehicles cannot accurately calculate the drag coefficient, thereby affecting the accuracy of calibration results.

The present disclosure proposes a multi-rotor drag coefficient calibration method, comprising: conducting flight tests at multiple set airspeeds along a straight and level flight path in both windless and windy environments, and during the flight tests, measuring the airspeed, attitude, and acceleration of the flight, and transmitting the airspeed, attitude, and acceleration to a flight control system of a multi-rotor aerial vehicle;
recording, by the flight control system, flight control logs based on a measurement sequence comprising airspeed, tilt angle, and acceleration during the flight tests;
selecting corresponding measurement combinations for the acceleration, cruise, and deceleration phases in each flight control log;
taking the least squares solution derived from a preset number of measurement combinations as the drag coefficient calibration result, and applying the drag coefficient calibration result to a preset real-time airspeed estimation algorithm to obtain the airspeed estimation result; and comparing the airspeed estimation result with the measurement results obtained by an airspeed meter during the flight tests, and verifying the accuracy of the drag coefficient calibration result and the real-time airspeed estimation algorithm based on the comparison result.

The present disclosure also proposes a multi-rotor drag coefficient calibration device, comprising a memory, a processor, and a computer program stored in the memory and executable on the processor. The computer program, when executed by the processor, implements the steps of the multi-rotor drag coefficient calibration method as described in any one of the above.

The present disclosure further proposes a computer-readable storage medium having a multi-rotor drag coefficient calibration program stored thereon. The multi-rotor drag coefficient calibration program, when executed by a processor, implements the steps of the multi-rotor drag coefficient calibration method as described in any one of the above.

Implementation of the multi-rotor drag coefficient calibration method, device, and computer-readable storage medium of the present disclosure involves conducting flight tests at multiple set airspeeds along a straight and level flight path in both windless and windy environments, and recording, by the flight control system, flight control logs based on a measurement sequence comprising airspeed, tilt angle, and acceleration during the flight tests; selecting corresponding measurement combinations for the acceleration, cruise, and deceleration phases in each flight control log; taking the least squares solution derived from a preset number of measurement combinations as the drag coefficient calibration result, and applying the drag coefficient calibration result to a preset real-time airspeed estimation algorithm to obtain the airspeed estimation result; comparing the airspeed estimation result with the measurement results obtained by an airspeed meter during the flight tests, and verifying the accuracy of the drag coefficient calibration result and the real-time airspeed estimation algorithm based on the comparison result. This achieves a low-cost experimental calibration algorithm that fully utilizes airspeed meter measurements, attitude measurements, and acceleration measurements during the flight test calibration process, efficiently and accurately calculating the multi-rotor drag coefficient function, and effectively verifying the accuracy of the drag coefficient calibration result and the real-time airspeed estimation algorithm.

### DESCRIPTION OF THE DRAWINGS

The present disclosure will be further described below in conjunction with the drawings and embodiments, in which:

FIG. 1 is a flowchart of the multi-rotor drag coefficient calibration method of the present disclosure; and

FIG. 2 is a diagram defining the coordinate system of the multi-rotor drag coefficient calibration method of the present disclosure.

### DETAILED DESCRIPTION

It should be understood that the specific embodiments described herein are only used to explain the present disclosure and are not intended to limit the present disclosure.

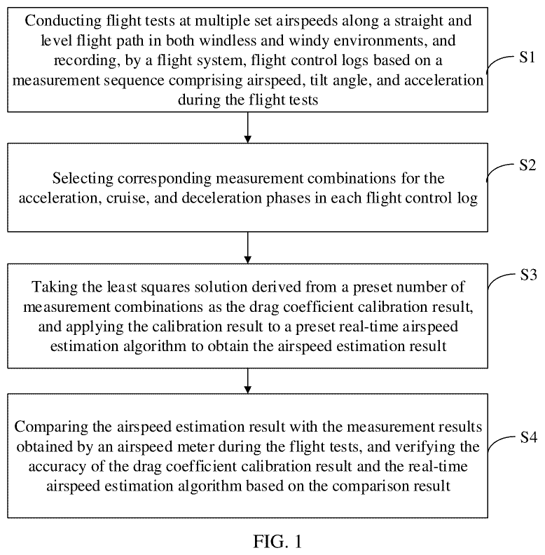

FIG. 1 is a flowchart of the multi-rotor drag coefficient calibration method of the present disclosure. This embodiment proposes a multi-rotor drag coefficient calibration method, which includes:
S1: Conducting flight tests at multiple set airspeeds along a straight and level flight path in both windless and windy environments, and recording, by a flight control system of a multi-rotor aerial vehicle, flight control logs based on a measurement sequence comprising airspeed, tilt angle, and acceleration during the flight tests;
S2: Selecting corresponding measurement combinations for the acceleration, cruise, and deceleration phases in each flight control log;
S3: Taking the least squares solution derived from a preset number of measurement combinations as the drag coefficient calibration result, and applying the drag coefficient calibration result to a preset real-time airspeed estimation algorithm to obtain the airspeed estimation result; and
S4: Comparing the airspeed estimation result with the measurement results obtained by an airspeed meter during the flight tests, and verifying the accuracy of the drag coefficient calibration result and the real-time airspeed estimation algorithm based on the comparison result.

Optionally, in this embodiment, an additional airspeed meter is installed on the multi-rotor aerial vehicle, and this airspeed meter is used solely for the aforementioned flight tests.

Optionally, in this embodiment, the airspeed meter is mounted on the top of the cockpit, away from the airflow interference of the propellers, and the airspeed meter is a pressure-based airspeed meter.

Optionally, in this embodiment, the measurement data from the airspeed meter is transmitted to the flight control system of the multi-rotor aerial vehicle via the aerial vehicle's data bus, and the flight control system calibrates and records the measurement data.

Optionally, in this embodiment, to ensure the robustness of the drag coefficient calibration results for the flight tests, multiple flight tests under different conditions are designed.

Optionally, in this embodiment, the flight test under a condition involves, in a windless environment, flying along a straight and level flight path with airspeeds set at 5 m/s, 10 m/s, 15 m/s, 20 m/s, 25 m/s, and 30 m/s, with the actual observed airspeed as the reference.

Optionally, in this embodiment, the flight test under another condition involves, in a windy environment, flying along a straight and level flight path with airspeeds set at 5 m/s, 10 m/s, 15 m/s, 20 m/s, 25 m/s, and 30 m/s, with the actual observed airspeed as the reference.

Optionally, for the aforementioned data collection and subsequent result calibration, this embodiment involves recording the generated “airspeed/tilt angle/acceleration” measurement sequences in the flight control logs during the flight tests, with a unified time reference. Further, for each flight log, different measurement combinations (Vᵢ θᵢ aₓᵢ)^{T} are selected from the “acceleration,” “cruise,” and “deceleration” phases. A total of 200 sets of measurement combinations are taken, and the least squares solution of the 200 sets of measurement equations is calculated using the mathematical tool MATLAB to complete the calibration. Furthermore, the drag coefficient calibration results obtained are applied to a real-time airspeed estimation algorithm, and the accuracy of the drag coefficient calibration results and the real-time airspeed estimation algorithm is verified by comparing them with the airspeed meter measurements from the flight tests.

Based on the above calibration steps, the specific calibration principles are described below.

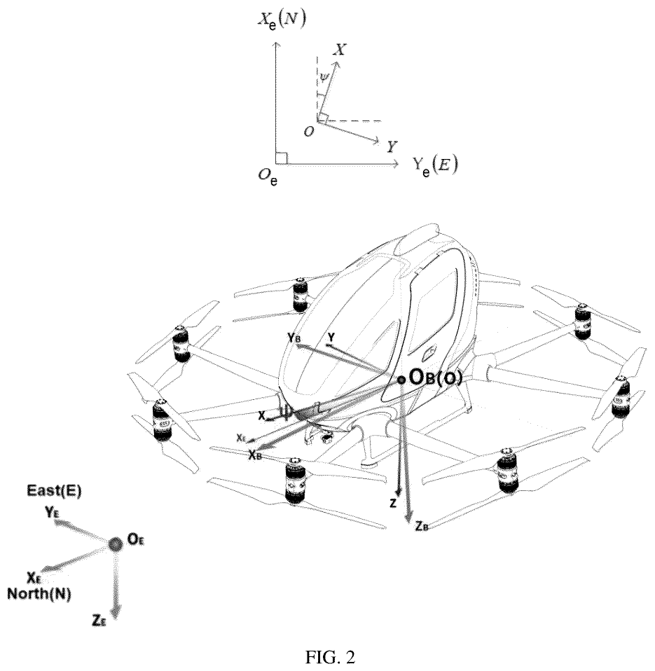

First, please refer to FIG. 2, which illustrates a diagram defining the coordinate system of the multi-rotor drag coefficient calibration method of the present disclosure. In this embodiment, the following coordinate systems are defined: first, the ground coordinate system O_{E}—X_{E}Y_{E}Z_{E}; second, the body coordinate system O_{B}−X_{B}Y_{B}Z_{B}; and third, the body horizontal coordinate system (i.e., a custom coordinate system) O−XYZ. The origin O is set at the center of mass of the aerial vehicle, OX is set in the plane of symmetry of the fuselage, pointing horizontally forward, OZ points vertically downward, and OY follows the right-hand rule, pointing horizontally to the right side of the fuselage.

Next, the following conventions are made for commonly used symbols: m represents the total mass of the aerial vehicle, a represents the linear acceleration of the center of mass, g represents gravitational acceleration, V represents airspeed, θ represents the horizontal tilt angle of the fuselage (it can be understood that, for longitudinal motion, this is the pitch angle), k₁(θ) represents the first-order drag coefficient function, k₂(θ) represents the second-order drag coefficient function, and k₃(θ) represents the third-order drag coefficient function. The first-order drag coefficient function k₁(θ), second-order drag coefficient function k₂(θ), and third-order drag coefficient function k₃(θ) are primarily related to the dynamics of the horizontal tilt angle. Furthermore, it is agreed that the subscript x, y, Z denotes the projection or component in the three axes of the body horizontal coordinate system, and the subscript x_{b}, y_{b}, z_{b} (or xₑ, yₑ, zₑ) denotes the projection or component in the three axes of the body coordinate system (or ground coordinate system).

Based on the above coordinate system definitions and symbol conventions, the following describes the calibration principle for the drag coefficient of a multi-rotor aerial vehicle.

In this embodiment, based on dynamics principles and combined with the control laws for multi-rotor attitude stabilization, altitude hold, and position tracking, a mathematical model for airspeed calculation is established:

$${ma}_{x} = - ( {k}_{1} ( θ ) \cdot V + {k}_{2} ( θ ) \cdot {V}^{2} + {k}_{3} ( θ ) \cdot {V}^{3} ) + mg tan θ . \qquad ( Equation 1 )$$

Equation 1 is converted into a calibration form:

$${k}_{1} ( θ ) \cdot V + {k}_{2} ( θ ) \cdot {V}^{2} + {k}_{3} ( θ ) \cdot {V}^{3} = m \cdot ( g tan θ - {a}_{x} ) , \qquad ( Equation 2 )$$

where the first-order drag coefficient function k₁(θ), second-order drag coefficient function k₂(θ), and third-order drag coefficient function k₃(θ) are all undetermined functions with unknown analytical forms, the tilt angle θ and acceleration aₓ are measured by attitude and acceleration sensors, and the airspeed V is measured by a pressure-based airspeed meter.

In this embodiment, a fifth-order Taylor expansion is performed on the first-order drag coefficient function k₁(θ), the second-order drag coefficient function k₂(θ), and the third-order drag coefficient function k₃(θ):

$$\{ \begin{matrix}{k}_{1} ( θ ) = {K}_{10} + {K}_{11} θ + {K}_{12} {θ}^{2} + {K}_{13} {θ}^{3} + {K}_{14} {θ}^{4} + {K}_{15} {θ}^{5} \\ {k}_{2} ( θ ) = {K}_{20} + {K}_{21} θ + {K}_{22} {θ}^{2} + {K}_{23} {θ}^{3} + {K}_{24} {θ}^{4} + {K}_{25} {θ}^{5} \\ {k}_{3} ( θ ) = {K}_{30} + {K}_{31} θ + {K}_{32} {θ}^{2} + {K}_{33} {θ}^{3} + {K}_{34} {θ}^{4} + {K}_{35} {θ}^{5}\end{matrix} . \qquad ( Equation 3 )$$

Through Equation 3, the calibration of the first-order drag coefficient function k₁(θ), the second-order drag coefficient function k₂(θ), and the third-order drag coefficient function k₃(θ) is transformed into the calibration of constant coefficients K₁₀, K₁₁, . . . , K₁₅; K₂₀, K₂₁, . . . , K₂₅; K₃₀, K₃₁, . . . , K₃₅.

In this embodiment, by substituting Equation 3 into Equation 2 and converting it into matrix form, the calibration constraint equation is obtained:

$${( V , V θ , … , V {θ}^{5} ; {V}^{2} , {V}^{2} θ , … , {V}^{2} {θ}^{5} \text{;;} {V}^{3} , {V}^{3} θ , … , {V}^{3} {θ}^{5} )}_{1 \times 18} \cdot {( \begin{matrix}{K}_{10} \\ {K}_{11} \\ ⋮ \\ {K}_{15} \\ {K}_{20} \\ {K}_{21} \\ ⋮ \\ {K}_{25} \\ {K}_{30} \\ {K}_{31} \\ ⋮ \\ {K}_{35}\end{matrix} )}_{18 \times 1} = m ( g tan θ - {a}_{x} ) . \qquad ( Equation 4 )$$

In this embodiment, vectors α, x, and scalar n are defined, where:

$$α = {( V , V θ , … , V {θ}^{5} ; {V}^{2} , {V}^{2} θ , … , {V}^{2} {θ}^{5} \text{;;} {V}^{3} , {V}^{3} θ , … , {V}^{3} {θ}^{5} )}^{T} , \qquad ( Equation 5 )$$

$$x = {( {K}_{10} , {K}_{11} , … , {K}_{15} ; {K}_{20} , {K}_{21} , … , {K}_{25} ; {K}_{30} , {K}_{31} , … , {K}_{35} )}^{T} , \qquad ( Equation 6 )$$

$$y = m ( g tan θ - {a}_{x} ) . \qquad ( Equation 7 )$$

The calibration constraint equation is simplified as:

$${α}^{{}_{T}} \cdot x = y . \qquad ( Equation 8 )$$

In this embodiment, during the flight tests, n sets of different measurement sequences are obtained:

$$( \begin{matrix}{V}_{1} \\ {θ}_{1} \\ {a}_{x 1}\end{matrix} ) , ( \begin{matrix}{V}_{2} \\ {θ}_{2} \\ {a}_{x 2}\end{matrix} ) , … , ( \begin{matrix}{V}_{i} \\ {θ}_{i} \\ {a}_{xi}\end{matrix} ) , … , ( \begin{matrix}{V}_{n} \\ {θ}_{n} \\ {a}_{xn}\end{matrix} ) , \qquad ( Equation 9 )$$

where the measurement combination

$${( {V}_{i} {θ}_{i} {a}_{x i} )}_{i = 1 … n}^{T}$$

of the measurement sequences is obtained from an actual straight and level flight process.

In this embodiment, it is ensured that the measurement combination satisfies Equation 8 based on straight and level flight;
The n sets of measurement combinations are substituted into Equation 5 and Equation 7 to obtain n sets of αᵢ, yᵢ;
The n sets of αᵢ, yᵢ are substituted into Equation 8 to obtain n sets of measurement equations:

$$\{ \begin{matrix}{α}_{1}^{T} \cdot x = {y}_{1} \\ {α}_{2}^{T} \cdot x = {y}_{2} \\ ⋮ \\ {α}_{i}^{T} \cdot x = {y}_{i} \\ ⋮ \\ {α}_{n}^{T} \cdot x = {y}_{n}\end{matrix} . \qquad ( Equation 10 )$$

In this embodiment, when n>18, the least squares solution of
X is obtained from the n sets of measurement equations;

Through the least squares solution, the calibration of the constant coefficients is completed, i.e., as the calibration of the first-order drag coefficient function k₁(θ), the second-order drag coefficient function k₂(θ), and the third-order drag coefficient function k₃(θ).

The beneficial effects of this embodiment lie in conducting flight tests at multiple set airspeeds along a straight and level flight path in both windless and windy environments, and recording, by the flight control system, flight control logs based on a measurement sequence comprising airspeed, tilt angle, and acceleration during the flight tests; selecting corresponding measurement combinations for the acceleration, cruise, and deceleration phases in each flight control log; taking the least squares solution derived from a preset number of measurement combinations as the drag coefficient calibration result, and applying the drag coefficient calibration result to a preset real-time airspeed estimation algorithm to obtain the airspeed estimation result; comparing the airspeed estimation result with the measurement results obtained by an airspeed meter during the flight tests, and verifying the accuracy of the drag coefficient calibration result and the real-time airspeed estimation algorithm based on the comparison result. This achieves a low-cost experimental calibration algorithm that fully utilizes airspeed measurements, attitude measurements, and acceleration measurements during the flight test calibration process, efficiently and accurately calculating the multi-rotor drag coefficient function, and effectively verifying the accuracy of the drag coefficient calibration result and the estimation algorithm.

Based on the above embodiment, the present disclosure also proposes a multi-rotor drag coefficient calibration device, comprising a memory, a processor, and a computer program stored in the memory and executable on the processor. The computer program, when executed by the processor, implements the steps of the multi-rotor drag coefficient calibration method as described in any one of the above.

It should be noted that the device embodiment and the method embodiment belong to the same concept, and the specific implementation process is detailed in the method embodiment. The technical features in the method embodiment are correspondingly applicable in the device embodiment, and thus are not repeated here.

Based on the above embodiment, the present disclosure also proposes a computer-readable storage medium having a multi-rotor drag coefficient calibration program stored thereon. The multi-rotor drag coefficient calibration program, when executed by a processor, implements the steps of the multi-rotor drag coefficient calibration method as described in any one of the above.

It should be noted that the medium embodiment and the method embodiment belong to the same concept, and the specific implementation process is detailed in the method embodiment. The technical features in the method embodiment are correspondingly applicable in the medium embodiment, and thus are not repeated here.

It should be noted that, in this document, the terms “comprise,” “include,” or any other variations thereof are intended to cover a non-exclusive inclusion, such that a process, method, article, or device that comprises a series of elements includes not only those elements but also other elements not explicitly listed, or elements inherent to such a process, method, article, or device. In the absence of further restrictions, an element defined by the phrase “comprising a . . . ” does not exclude the presence of other identical elements in the process, method, article, or device that comprises the element.

Through the description of the above embodiments, those skilled in the art can clearly understand that the methods of the above embodiments can be implemented by means of software combined with a necessary general hardware platform, or, of course, by hardware, but in many cases, the former is a better implementation. Based on this understanding, the technical solution of the present disclosure, or the part that contributes to the prior art, can be embodied in the form of a software product. The computer software product is stored in a storage medium (such as ROM/RAM, magnetic disk, or optical disk) and includes several instructions to enable a terminal (which may be a mobile phone, computer, server, air conditioner, network device, etc.) to execute the methods described in the various embodiments of the present disclosure.

The embodiments of the present disclosure have been described above in conjunction with the accompanying drawings. However, the present disclosure is not limited to the specific embodiments described above, which are merely illustrative and not restrictive. Those skilled in the art, under the inspiration of the present disclosure and without departing from the spirit of the disclosure and the scope protected by the claims, may make many variations, all of which fall within the protection of the present disclosure.

### INDUSTRIAL APPLICABILITY

The implementation of the multi-rotor drag coefficient calibration method, device, and computer-readable storage medium of the present disclosure involves conducting flight tests at multiple set airspeeds along a straight and level flight path in both windless and windy environments, and recording, by the flight control system, flight control logs based on a measurement sequence comprising airspeed, tilt angle, and acceleration during the flight tests; selecting corresponding measurement combinations for the acceleration, cruise, and deceleration phases in each flight control log; taking the least squares solution derived from a preset number of measurement combinations as the drag coefficient calibration result, and applying the drag coefficient calibration result to a preset real-time airspeed estimation algorithm to obtain the airspeed estimation result; comparing the airspeed estimation result with the measurement results obtained by an airspeed meter during the flight tests, and verifying the accuracy of the drag coefficient calibration result and the real-time airspeed estimation algorithm based on the comparison result. This achieves a low-cost experimental calibration algorithm that fully utilizes airspeed meter measurements, attitude measurements, and acceleration measurements during the flight test calibration process, efficiently and accurately calculating the multi-rotor drag coefficient function, and effectively verifying the accuracy of the drag coefficient calibration result and the estimation algorithm. Therefore, it has industrial applicability.

What is claimed is:

1. A multi-rotor drag coefficient calibration method, comprising:
conducting flight tests at multiple set airspeeds along a straight and level flight path in both windless and windy environments, and during the flight tests, measuring airspeed, attitude, and acceleration of flight, and transmitting the airspeed, the attitude, and the acceleration to a flight control system of a multi-rotor aerial vehicle;
recording, by the flight control system, flight control logs based on a measurement sequence comprising the airspeed, tilt angle, and the acceleration during the flight tests;
selecting corresponding measurement combinations for acceleration, cruise, and deceleration phases in each flight control log;
taking a least squares solution derived from a preset number of measurement combinations as a drag coefficient calibration result, and applying the drag coefficient calibration result to a preset real-time airspeed estimation algorithm to obtain an airspeed estimation result; and
comparing the airspeed estimation result with measurement results obtained by an airspeed meter during the flight tests, and verifying accuracy of the drag coefficient calibration result and the real-time airspeed estimation algorithm based on a comparison result.

2. The multi-rotor drag coefficient calibration method according to claim 1, wherein the method further comprises:
establishing a mathematical model for airspeed calculation based on dynamics principles and control laws for multi-rotor attitude stabilization, altitude hold, and position tracking:
$$m {a}_{x} = - ( {k}_{1} ( θ ) \cdot V + {k}_{2} ( θ ) \cdot {V}^{2} + {k}_{3} ( θ ) \cdot {V}^{3} ) + mg tan θ ; \qquad ( Equation l )$$
converting the Equation 1 into a calibration form:
$${k}_{1} ( θ ) \cdot V + {k}_{2} ( θ ) \cdot {V}^{2} + {k}_{3} ( θ ) \cdot {V}^{3} = m \cdot ( g tan θ - {a}_{x} ) ; \qquad ( Equation 2 )$$
wherein a first-order drag coefficient function k₁(θ), a second-order drag coefficient function k₂(θ), and a third-order drag coefficient function k₃(θ) are all undetermined functions with unknown analytical forms, the tilt angle θ and the acceleration aₓ are measured by attitude and acceleration sensors, and the airspeed V is measured by a pressure-based airspeed meter.

3. The multi-rotor drag coefficient calibration method according to claim 2, wherein the method further comprises:
performing a fifth-order Taylor expansion on the first-order drag coefficient function k₁(θ), the second-order drag coefficient function k₂(θ), and the third-order drag coefficient function
$${k}_{3} ( θ ) : \{ \begin{matrix}{k}_{1} ( θ ) = {K}_{10} + {K}_{11} θ + {K}_{12} {θ}^{2} + {K}_{13} {θ}^{3} + {K}_{14} {θ}^{4} + {K}_{15} {θ}^{5} \\ {k}_{2} ( θ ) = {K}_{20} + {K}_{21} θ + {K}_{22} {θ}^{2} + {K}_{23} {θ}^{3} + {K}_{24} {θ}^{4} + {K}_{25} {θ}^{5} \\ {k}_{3} ( θ ) = {K}_{30} + {K}_{31} θ + {K}_{32} {θ}^{2} + {K}_{33} {θ}^{3} + {K}_{34} {θ}^{4} + {K}_{35} {θ}^{5}\end{matrix} ; \qquad ( Equation 3 )$$
through the Equation 3, converting calibration of the first-order drag coefficient function k₁(θ), the second-order drag coefficient function k₂(θ), and the third-order drag coefficient function k₃(θ) into calibration of constant coefficients K₁₀, K₁₁, . . . , K₁₅; K₂₀, K₂₁, . . . , K₂₅; K₃₀, K₃₁, . . . , K₃₅.

4. The multi-rotor drag coefficient calibration method according to claim 3, wherein the method further comprises:
substituting the Equation 3 into the Equation 2 and converting the Equation 3 into a matrix form to obtain a calibration constraint equation:
$${( V , V θ , … , V {θ}^{5} ; {V}^{2} , {V}^{2} θ , … , {V}^{2} {θ}^{5} \text{;;} {V}^{3} , {V}^{3} θ , … , {V}^{3} {θ}^{5} )}_{1 \times 18} \cdot {( \begin{matrix}{K}_{10} \\ {K}_{11} \\ ⋮ \\ {K}_{15} \\ {K}_{20} \\ {K}_{21} \\ ⋮ \\ {K}_{25} \\ {K}_{30} \\ {K}_{31} \\ ⋮ \\ {K}_{35}\end{matrix} )}_{18 \times 1} = m ( g tan θ - {a}_{x} ) . \qquad ( Equation 4 )$$

5. The multi-rotor drag coefficient calibration method according to claim 4, wherein the method further comprises:
defining vectors α, x, and scalar n, wherein:
$$α = {( V , V θ , … , V {θ}^{5} ; {V}^{2} , {V}^{2} θ , … , {V}^{2} {θ}^{5} \text{;;} {V}^{3} , {V}^{3} θ , … , {V}^{3} {θ}^{5} )}^{T} ; \qquad ( Equation 5 )$$
$$x = {( {K}_{10} , {K}_{11} , … , {K}_{15} ; {K}_{20} , {K}_{21} , … , {K}_{25} ; {K}_{30} , {K}_{31} , … , {K}_{35} )}^{T} ; \qquad ( Equation 6 )$$
$$y = m ( g tan θ - {a}_{x} ) ; \qquad ( Equation 7 )$$
simplifying the calibration constraint equation as:
$${α}^{{}_{T}} \cdot x = y . \qquad ( Equation 8 )$$

6. The multi-rotor drag coefficient calibration method according to claim 5, wherein the method further comprises:
during the flight tests, obtaining n sets of different measurement sequences:
$$( \begin{matrix}{V}_{1} \\ {θ}_{1} \\ {a}_{x 1}\end{matrix} ) , ( \begin{matrix}{V}_{2} \\ {θ}_{2} \\ {a}_{x 2}\end{matrix} ) , … , ( \begin{matrix}{V}_{i} \\ {θ}_{i} \\ {a}_{xi}\end{matrix} ) , … , ( \begin{matrix}{V}_{n} \\ {θ}_{n} \\ {a}_{xn}\end{matrix} ) ; \qquad ( Equation 9 )$$
wherein a measurement combination
$${( \begin{matrix}{V}_{i} & {θ}_{i} & {a}_{xi}\end{matrix} )}_{i = 1 … n}^{T}$$
of measurement sequences is obtained from an actual straight and level flight process.

7. The multi-rotor drag coefficient calibration method according to claim 6, wherein the method further comprises:
ensuring that the measurement combination satisfies the Equation 8 based on straight and level flight;
substituting the n sets of measurement combinations into the Equation 5 and the Equation 7 to obtain n sets of αᵢ, yᵢ;
substituting the n sets of αᵢ, Vᵢ into the Equation 8 to obtain n sets of measurement equations:
$$\{ \begin{matrix}{α}_{1}^{T} \cdot x = {y}_{1} \\ {α}_{2}^{T} \cdot x = {y}_{2} \\ ⋮ \\ {α}_{i}^{T} \cdot x = {y}_{i} \\ ⋮ \\ {α}_{n}^{T} \cdot x = {y}_{n}\end{matrix} . \qquad ( Equation 10 )$$

8. The multi-rotor drag coefficient calibration method according to claim 7, wherein the method further comprises:
when n>18, obtaining the least squares solution of x from the n sets of measurement equations;
completing the calibration of the constant coefficients through the least squares solution, i.e., as the calibration of the first-order drag coefficient function k₁(θ), the second-order drag coefficient function k₂(θ), and the third-order drag coefficient function k₃(θ).

9. A multi-rotor drag coefficient calibration device, comprising a memory, a processor, and a computer program stored in the memory and executable on the processor, wherein the computer program, when executed by the processor, implements steps of the multi-rotor drag coefficient calibration method according to claim 1.

10. A multi-rotor drag coefficient calibration device, comprising a memory, a processor, and a computer program stored in the memory and executable on the processor, wherein the computer program, when executed by the processor, implements steps of the multi-rotor drag coefficient calibration method according to claim 2.

11. A multi-rotor drag coefficient calibration device, comprising a memory, a processor, and a computer program stored in the memory and executable on the processor, wherein the computer program, when executed by the processor, implements steps of the multi-rotor drag coefficient calibration method according to claim 3.

12. A multi-rotor drag coefficient calibration device, comprising a memory, a processor, and a computer program stored in the memory and executable on the processor, wherein the computer program, when executed by the processor, implements steps of the multi-rotor drag coefficient calibration method according to claim 4.

13. A multi-rotor drag coefficient calibration device, comprising a memory, a processor, and a computer program stored in the memory and executable on the processor, wherein the computer program, when executed by the processor, implements steps of the multi-rotor drag coefficient calibration method according to claim 5.

14. A multi-rotor drag coefficient calibration device, comprising a memory, a processor, and a computer program stored in the memory and executable on the processor, wherein the computer program, when executed by the processor, implements steps of the multi-rotor drag coefficient calibration method according to claim 6.

15. A computer-readable storage medium having a multi-rotor drag coefficient calibration program stored thereon, wherein the multi-rotor drag coefficient calibration program, when executed by a processor, implements steps of the multi-rotor drag coefficient calibration method according to claim 1.

16. A computer-readable storage medium having a multi-rotor drag coefficient calibration program stored thereon, wherein the multi-rotor drag coefficient calibration program, when executed by a processor, implements steps of the multi-rotor drag coefficient calibration method according to claim 2.

17. A computer-readable storage medium having a multi-rotor drag coefficient calibration program stored thereon, wherein the multi-rotor drag coefficient calibration program, when executed by a processor, implements steps of the multi-rotor drag coefficient calibration method according to claim 3.

18. A computer-readable storage medium having a multi-rotor drag coefficient calibration program stored thereon, wherein the multi-rotor drag coefficient calibration program, when executed by a processor, implements steps of the multi-rotor drag coefficient calibration method according to claim 4.

19. A computer-readable storage medium having a multi-rotor drag coefficient calibration program stored thereon, wherein the multi-rotor drag coefficient calibration program, when executed by a processor, implements steps of the multi-rotor drag coefficient calibration method according to claim 5.

20. A computer-readable storage medium having a multi-rotor drag coefficient calibration program stored thereon, wherein the multi-rotor drag coefficient calibration program, when executed by a processor, implements steps of the multi-rotor drag coefficient calibration method according to claim 6.
